(19) United States
(12) Patent Application Publication
(10) Pub. No.: US 2004/0125292 A1
(43) Pub. Date: Jul. 1, 2004

(54) Liquid crystal display device and electronic equipment

(75) Inventor: Tsuyoshi Maeda, Ryuo-cho (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/690,607

(22) Filed: Oct. 23, 2003

(30) Foreign Application Priority Data
Nov. 8, 2002 (JP) 2002-325241
Jul. 29, 2003 (JP) 2003-203101

(51) Int. Cl. G02F 1/1335

(52) U.S. Cl. 349/117

(57) ABSTRACT

To provide reflective display and transmissive display with wider view angles and higher contrast in a transflective liquid crystal display device equipped with both reflective and transmissive structures, one dot includes a reflective display region used for reflective display and a transmissive display region used for transmissive display. A liquid crystal layer is formed of a nematic liquid crystal having negative permittivity anisotropy oriented substantially perpendicularly to substrates. A first retardation film having optical biaxiality and a first polarizer are disposed in this order on the outer side of an upper substrate, while a second retardation film having optical biaxiality, a second polarizer and an illuminating device are disposed in this order on the outer side of a lower substrate.

### BACKGROUND OF THE INVENTION

1. Field of Invention

The present invention relates to a liquid crystal display device and electronic equipment and, more particularly, to a technology for allowing a transflective liquid crystal display device having both reflective and transmissive structures to accomplish reflective display and transmissive display with wider view angles and higher contrasts.

2. Description of Related Art

A transflective liquid crystal display device having both reflective and transmissive display modes is adapted to switch between the reflective display mode and the transmissive display mode according to the ambient brightness, so as to allow clear display to be achieved even in a dark environment, while reducing power consumption at the same time.

As such a transflective liquid crystal display device, a liquid crystal display device has been proposed, in which a liquid crystal layer is sandwiched between a light transmitting upper substrate and lower substrate, the inner surface of the lower substrate is provided with a reflection film composed of a metal film, such as aluminum film, with an opening for transmitting light formed therein, and the reflection film functions as a transflective film. In this case, in the reflection mode, the external light incident upon the upper substrate passes through the liquid crystal layer, then the light is reflected by the reflection film on the inner surface of the lower substrate. The light then passes through the liquid crystal layer again and is directed to the upper substrate for display use. In the transmissive mode, the light from the backlight incident upon the lower substrate passes through the opening formed in the reflection film into the liquid crystal layer, then the light is directed to the upper substrate for display use. Thus, the region of the reflection film, wherein the opening is formed, provides the transmissive display region, while the region free of the opening provides the reflective display region (refer to, for example, Japanese Unexamined Patent Application Publication No. 11-242226).

As another related art, there has been proposed a homeotropic alignment type liquid crystal display device featuring improved view angle characteristics of the liquid crystal thereof (refer to, for example, Japanese Unexamined Patent Application Publication No. 5-113561).

### SUMMARY OF THE INVENTION

The related art transflective liquid crystal display device having the reflective and transmissive display modes have small view angles both in the reflection display mode and the transmissive display mode. This requires that the polarizer and the retardation film adjacent to an observer (the upper side of the transflective liquid crystal display device) and the liquid crystal layer in the reflective display region through which incident light passes twice must be designed for the reflective display. Similarly, the polarizer and the retardation film adjacent to an observer (the upper side of the transflective liquid crystal display device), the polarizer and retardation film adjacent to an illumination device (the lower side of the transflective liquid crystal display device), and the liquid crystal layer of the transmissive display region through which incident light from the illuminating device passes once must be designed for the transmissive display.

Thus, it has been extremely difficult to design both reflection display and transmissive display with wider view angles and higher contrasts.

Furthermore, electronic equipment incorporating the related art transflective liquid crystal display device has a problem of narrow view angles with consequent limited visible display range.

Accordingly, the present invention provides a transflective liquid crystal display device having both reflective and transmissive structures to accomplish reflective display and transmissive display with wider view angles and higher contrasts.

The present invention provides electronic equipment incorporating a display device having high visibility.

To address the aforesaid problems, a liquid crystal display device according to an aspect of the present invention is a liquid crystal display device having a liquid crystal layer sandwiched between a first substrate and a second substrate, wherein one dot includes a reflective display region used for reflective display and a transmissive display region used for transmissive display, the liquid crystal layer includes a nematic liquid crystal having negative permittivity anisotropy oriented substantially perpendicularly to the substrates, a first retardation film and a first polarizer are disposed in this order on the outer side of the first substrate, a second retardation film, a second polarizer and an illuminating device are disposed in this order on the outer side of the second substrate, and at least one of the first retardation film and the second retardation film has optical biaxiality.

With the above arrangement, the first polarizer, the first retardation film and the vertically aligned liquid crystal layer make it possible to achieve reflective display with high contrast, and the first polarizer, the first retardation film and the vertically aligned liquid crystal layer, the second retardation film and the second polarizer make it possible to achieve transmissive display with high contrast. Moreover, since at least either the first retardation film or the second retardation film has optical biaxiality, the view angle characteristics of the vertically aligned liquid crystal layer when observed aslant can be compensated, thus allowing a transmissive display with wider view angles to be achieved.

A liquid crystal display device according to an aspect of the present invention is a liquid crystal display device having a liquid crystal layer sandwiched between a first substrate and a second substrate, wherein one dot includes a reflective display region used for reflective display and a transmissive display region used for transmissive display, the liquid crystal layer includes a nematic liquid crystal having negative permittivity anisotropy oriented substantially perpendicularly to the substrates, a first retardation film having optical biaxiality and a first polarizer are disposed in this order on the outer side of the first substrate, and a second retardation film having optical biaxiality, a second polarizer and an illuminating device are disposed in this order on the outer side of the second substrate.

With the above arrangement, the first polarizer, the first retardation film and the vertically aligned liquid crystal layer make it possible to achieve reflective display with high contrast, and the first polarizer, the first retardation film, the vertically aligned liquid crystal layer, the second retardation film and the second polarizer make it possible to achieve transmissive display with high contrast. Moreover, since the first retardation film and the second retardation film have optical biaxiality, the view angle characteristics of the vertically aligned liquid crystal layer when observed aslant can be compensated, thus allowing both reflective display and transmissive display with wider view angles to be achieved.

A liquid crystal display device according to an aspect of the present invention is a liquid crystal display device having a liquid crystal layer sandwiched between a first subtrate and a second substrate, wherein one dot includes a reflective display region used for reflective display and a transmissive display region used for transmissive display, the liquid crystal layer includes a nematic liquid crystal having negative permittivity anisotropy oriented substantially perpendicularly to the substrates, a first retardation film having optical biaxiality and a first polarizer are disposed in this order on the outer side of the first substrate, and a third retardation film having optically negative uniaxiality, a fourth retardation film having optically positive uniaxiality, a second polarizer and an illuminating device are disposed in this order on the outer side of the second substrate.

Alternatively, the liquid crystal display device may include a liquid crystal layer sandwiched between a first substrate and a second substrate, wherein one dot includes a reflective display region used for reflective display and a transmissive display region used for transmissive display, the liquid crystal layer has a nematic liquid crystal having negative permittivity anisotropy oriented substantially perpendicularly to the substrates, a first retardation film having optical biaxiality and a first polarizer are disposed in this order on the outer side of the first substrate, and a fourth retardation film having optically positive uniaxiality, a second polarizer and an illuminating device are disposed in this order on the outer side of the second substrate.

With the arrangements described above, the first polarizer, the first retardation film and the vertically aligned liquid crystal layer make it possible to achieve reflective display with high contrast, and the first polarizer, the first retardation film, the vertically aligned liquid crystal layer, the fourth retardation film having optically positive uniaxiality, and the second polarizer make it possible to achieve transmissive display with high contrast. Moreover, since the first retardation film has optical biaxiality, the view angle characteristics of the vertically aligned liquid crystal layer when observed aslant can be compensated, thus allowing a reflective display with wider view angles to be achieved.

Furthermore, in addition to the biaxial first retardation film, the third retardation film having optically negative uniaxiality is disposed between the fourth retardation film having optically positive uniaxiality and the liquid crystal layer so as to make it possible to compensate the view angle characteristics of the vertically aligned liquid crystal layer when observed aslant, thus allowing transmissive display with wider angles of visibility to be achieved. It is also possible to add the function of the third retardation film having the optically negative uniaxiality to the optically biaxial first retardation film.

A liquid crystal display device according to an aspect of the present invention is a liquid crystal display device having a liquid crystal layer sandwiched between a first substrate and a second substrate, wherein one dot includes a reflective display region used for reflective display and a transmissive display region used for transmissive display, the liquid crystal layer includes a nematic liquid crystal having negative permittivity anisotropy oriented substantially perpendicularly to the substrates, a fifth retardation film having optically negative uniaxiality, a sixth retardation film having optically positive uniaxiality, and a first polarizer are disposed in this order on the outer side of the first substrate, and a second retardation film having optical biaxiality, a second polarizer and an illuminating device are disposed in this order on the outer side of the second substrate.

Alternatively, the liquid crystal display device may have a liquid crystal layer sandwiched between the first substrate and the second substrate, wherein one dot includes a reflective display region used for reflective display and a transmissive display region used for transmissive display, the liquid crystal layer includes a nematic liquid crystal having negative permittivity anisotropy oriented substantially perpendicularly to the substrates, a sixth retardation film having optically positive uniaxiality and a first polarizer are disposed in this order on the outer side of the first substrate, and a second retardation film having optical biaxiality, a second polarizer and an illuminating device are disposed in this order on the outer side of the second substrate.

With the above arrangement, the first polarizer, the sixth retardation film having optically positive uniaxiality and the vertically aligned liquid crystal layer make it possible to achieve reflective display with high contrast, and the first polarizer, the sixth retardation film having optically positive uniaxiality, the vertically aligned liquid crystal layer, the second retardation film having optical biaxiality and the second polarizer make it possible to achieve transmissive display with high contrast. Moreover, the view angle characteristics of the vertically aligned liquid crystal layer when observed aslant can be compensated by providing the fifth retardation film having optically negative uniaxiality between the sixth retardation film having optically positive uniaxiality and the liquid crystal layer, thus allowing reflective display with wider view angles to be achieved. Furthermore, adding the second retardation film having optical biaxiality in addition to the fifth retardation film having optically negative uniaxiality between the liquid crystal layer and the second polarizer makes it possible to compensate the view angle characteristics of the vertically aligned liquid crystal layer when observed aslant, thus allowing transmissive display with wider view angles to be allowed.

The liquid crystal display device according to an aspect of the present invention is characterized in that the thickness of the liquid crystal layer of the reflective display region is smaller than the thickness of the liquid crystal layer of the transmissive region.

The above arrangement makes it possible to achieve bright reflective display and transmissive display with higher contrast. In a transflective liquid crystal display device, if, for example, the thickness of the liquid crystal layer is denoted by d, the refractive index anisotropy of the liquid crystal is denoted by Δn, and the retardation (phase difference) of the liquid crystal represented in terms of the integrated value of the former two is denoted by Δnd, then the retardation And of the liquid crystal of the portion for performing reflective display is expressed by 2×Δnd since incident light passes through the liquid crystal layer twice before reaching an observer, while the retardation Δnd of the liquid crystal for performing transmissive display is expressed by 1×Δnd since the light from the illuminating means (backlight) passes through the liquid crystal layer only once. Setting the thickness of the liquid crystal layer of the reflective display region smaller than the thickness of the liquid crystal layer of the transmissive region makes it possible to optimize the Δnd of both reflective region and transmissive region, thus allowing bright reflective display and transmissive display with high contrast to be achieved.

The liquid crystal display device according to the present invention is characterized in that, if the refractive indexes of the first retardation film and the second retardation film in the direction of a Z-axis, which is the direction of their thickness, are denoted by nz1 and nz2, respectively, the refractive indexes thereof in the direction of an X-axis, which is one direction in the plane perpendicular to the Z-axis, are denoted by nx1 and nx2, respectively, the refractive indexes thereof in the direction of a Y-axis, which is the direction perpendicular to the Z-axis and the X-axis, are denoted by ny1 and ny2, respectively, and the thickness thereof in the Z-axis direction is denoted by d1 and d2, respectively, then nx1>ny1>nz1 and nx2>ny2>nz2 hold, and a sum W1 of the phase difference value within the XY plane and in the Z-axis direction in the first retardation film ((nx1+ny1)/2−nz1)×d1 and the phase difference value in the second retardation film ((nx2+ny2)/2−nz2)×d2 is expressed as 0.5×Rt≦W1≦0.75×Rt if the phase difference value of the liquid crystal layer in the transmissive region is denoted by Rt.

With this arrangement, the view angle characteristics of the vertically aligned liquid crystal layer when observed aslant can be compensated, allowing transmissive display with wider view angles to be achieved. The view angle characteristics of the vertically aligned liquid crystal layer in the transmissive region can be optically compensated by defining the phase difference value within the XY plane and in the Z-axis direction in the first retardation film ((nx1+ny1)/2−nz1)×d1 and the phase difference value within the XY plane and in the Z-axis direction in the second retardation film ((nx2+ny2)/2−nz2)×d2 as the range of the present invention. The first retardation film and the second retardation film may be constructed using a plurality of optical films. In this case, any number of films may be used as long as the total number of films satisfies the range of the present invention. Here, the phase difference value Rt of the liquid crystal layer is represented as the integrated value Δn×d when the thickness of the liquid crystal layer is denoted by d and the refractive index anisotropy of the liquid crystal is denoted by Δn.

The liquid crystal display device according to an aspect the present invention is characterized in that, if the refractive indexes of the first retardation film and the third retardation film in the direction of the Z-axis, which is the direction of their thickness, are denoted by nz1 and nz3, respectively, the refractive indexes thereof in the direction of the X-axis, which is one direction in the plane perpendicular to the Z-axis, are denoted by nx1 and nx3, respectively, the refractive indexes thereof in the direction of the Y-axis, which is the direction perpendicular to the Z-axis and the X-axis, are denoted by ny1 and ny3, respectively, and the thickness thereof in the Z-axis direction is denoted by d1 and d3, respectively, then nx1>ny1>nz1 and nx3≈ny3>nz3 hold, and a sum W2 of the phase difference value within the XY plane and in the Z-axis direction of the first retardation film ((nx1+ny1)/2−nz1)×d1 and the phase difference value in the third retardation film ((nx3+ny3)/2−nz1)×d3 is expressed as 0.5×Rt≦W2≦0.75×Rt if the phase difference value of the liquid crystal layer in the transmissive region is denoted by Rt.

The liquid crystal display device according to an aspect of the present invention is characterized in that, if the refractive indexes of the first retardation film, the third retardation film and the fourth retardation film in the direction of the Z-axis, which is the direction of their thickness, are denoted by nz1, nz3 and nz4, respectively, the refractive indexes thereof in the direction of the X-axis, which is one direction in the plane perpendicular to the Z-axis, are denoted by nx1, nx3, and nx4, respectively, the refractive indexes thereof in the direction of the Y-axis, which is the direction perpendicular to the Z-axis and the X-axis, are denoted by ny1, ny3 and ny4, respectively, and the thicknesses thereof in the Z-axis direction are denoted byd1, d3 and d4, respectively, then nx1>ny1>nz1 and nx3≈ny3>nz3 and nx4>ny4≈nz4 hold, and the sum W2 of the phase difference value within the XY plane and in the Z-axis direction of the first retardation film ((nx1+ny1)/2−nz1)×d1, the phase difference value in the third retardation film ((nx3+ny3)/2−nz3)×d3, and the phase difference value within the XY plane and in the Z-axis direction of the fourth retardation film ((nx4+ny4)/2−nz4)×d4 is expressed as 0.5×Rt≦W2≦0.75×Rt if the phase difference value of the liquid crystal layer in the transmissive region is denoted by Rt.

The liquid crystal display device according to an aspect of the present invention is characterized in that, if the refractive indexes of the first retardation film and the fourth retardation film in the direction of the Z-axis, which is the direction of their thickness, are denoted by nz1 and nz4, respectively, the refractive indexes thereof in the direction of the X-axis, which is one direction in the plane perpendicular to Z-axis, are denoted by nx1 and nx4, respectively, the refractive indexes thereof in the direction of the Y-axis, which is the direction perpendicular to the Z-axis and the X-axis, are denoted by ny1 and ny4, and the thicknesses thereof in the Z-axis direction are denoted by d1 and d4, respectively, then nx1>ny1>nz1 and nx4>ny4≈nz4 hold, and the sum W2 of the phase difference value within the XY plane and in the Z-axis direction in the first retardation film ((nx1+ny1)/2−nz1)×d1 and the phase difference value within the XY plane and in the Z-axis direction of the fourth retardation film ((nx4+ny4)/2−nz4)×d4 is expressed as 0.5×Rt≦W2≦0.75×Rt if the phase difference value of the liquid crystal layer in the transmissive region is denoted by Rt.

With the arrangements described above, the view angle characteristics of the vertically aligned liquid crystal layer when observed aslant can be compensated, allowing transmissive display with wider view angles to be achieved. The view angle characteristics of the vertically aligned liquid crystal layer in the transmissive region can be optically compensated by defining the phase difference value within the XY plane and in the Z-axis direction of the first retardation film ((nx1+ny1)/2−nz 1)×d1 and the phase difference value within the XY plane and in the Z-axis direction in the third retardation film ((nx3+ny3)/2−nz3)×d3 as the range of an aspect of the present invention. Furthermore, the view angle characteristics of the vertically aligned liquid crystal layer in the transmissive region can be optically compensated by adding the phase difference value within the XY plane and in the Z-axis direction in the fourth retardation film ((nx4+ny4)/2−nz4)×d4 to the range of an aspect of the present invention. It is also possible to optically compensate the view angle characteristics of the vertically aligned liquid crystal layer in the transmissive region by defining the phase difference value of the first retardation film and the phase difference value of the fourth retardation film as the range of an aspect of the present invention. The first retardation film may be constructed using a plurality of optical films. The third retardation film may be constructed using a plurality of optical films. In these cases, any number of films may be used as long as the total number of films satisfies the range of the present invention. Here, the phase difference value Rt of the liquid crystal layer is represented as the integrated value Δn×d when the thickness of the liquid crystal layer is denoted by d and the refractive index anisotropy of the liquid crystal is denoted by Δn.

The liquid crystal display device according to an aspect of the present invention is characterized in that, if the refractive indexes of the second retardation film and the fifth retardation film in the direction of the Z-axis, which is the direction of their thickness, are denoted by nz2 and nz5, respectively, the refractive indexes thereof in the direction of the X-axis, which is one direction in the plane perpendicular to the Z-axis, are denoted by nx2 and nx5, respectively, the refractive indexes thereof in the direction of the Y-axis, which is the direction perpendicular to the Z-axis and the X-axis, are denoted by ny2 and ny5, respectively, and the thicknesses thereof in the Z-axis direction are denoted by d2 and d5, respectively, then nx2>ny2>nz2 and nx5≈ny5>nz5 hold, and a sum W3 of the phase difference value within the XY plane and in the Z-axis direction in the second retardation film ((nx2+ny2)/2−nz2)×d2 and the phase difference value of the fifth retardation film ((nx5+ny5)/2−nz5)×d5 is expressed as 0.5×Rt≦W3≦0.75×Rt if the phase difference value of the liquid crystal layer in the transmissive region is denoted by Rt.

The liquid crystal display device according to an aspect of the present invention is characterized in that, if the refractive indexes of the second retardation film, the fifth retardation film and the sixth retardation film in the direction of the Z-axis, which is the direction of their thickness, are denoted by nz2, nz5 and nz6, respectively, the refractive indexes thereof in the direction of the X-axis, which is one direction in the plane perpendicular to Z-axis, are denoted by nx2, nx5, and nx6, respectively, the refractive indexes thereof in the direction of the Y-axis, which is the direction perpendicular to the Z-axis and the X-axis, are denoted by ny2, ny5 and ny6, respectively, and the thicknesses thereof in the Z-axis direction are denoted by d2, d5 and d6, respectively, then nx2>ny2>nz2, nx5≈ny5>nz5 and nx6>ny6≈nz6 hold, and the sum W3 of the phase difference value within the XY plane and in the Z-axis direction of the second retardation film ((nx2+ny2)/2−nz2)×d2, the phase difference value of the fifth retardation film ((nx5+ny5)/2−nz5)×d5, and the phase difference value within the XY plane and in the Z-axis direction of the sixth retardation film ((nx6+ny6)/2−nz6)×d6 is expressed as 0.5×Rt≦W3≦0.75×Rt if the phase difference value of the liquid crystal layer in the transmissive region is denoted by Rt.

The liquid crystal display device according to an aspect of the present invention is characterized in that, if the refractive indexes of the second retardation film and the sixth retardation film in the direction of the Z-axis, which is the direction of their thickness, are denoted by nz2 and nz6, respectively, the refractive indexes thereof in the direction of the X-axis, which is one direction in the plane perpendicular to Z-axis, are denoted by nx2 and nx6, respectively, the refractive indexes thereof in the direction of the Y-axis, which is the direction perpendicular to the Z-axis and the X-axis, are denoted by ny2 and ny6, respectively, and the thicknesses thereof in the Z-axis direction are denoted by d2 and d6, respectively, then nx2>ny2>nz2 and nx6>ny6≈nz6 hold, and the sum W3 of the phase difference value within the XY plane and in the Z-axis direction of the second retardation film ((nx2+ny2)/2−nz2)×d2 and the phase difference value within the XY plane and in the Z-axis direction of the sixth retardation film ((nx6+ny6)/2−nz6)×d6 is expressed as 0.5×Rt≦W3≦0.75×Rt if the phase difference value of the liquid crystal layer in the transmissive region is denoted by Rt.

With the arrangements described above, the view angle characteristics of the vertically aligned liquid crystal layer when observed aslant can be compensated, allowing transmissive display with wider view angles to be achieved. The view angle characteristics of the vertically aligned liquid crystal layer in the transmissive region can be optically compensated by defining the phase difference value within the XY plane and in the Z-axis direction of the second retardation film ((nx2+ny2)/2−nz2)×d2 and the phase difference value within the XY plane and in the Z-axis direction of the fifth retardation film ((nx5+ny5)/2−nz5)×d5 as the range of an aspect of the present invention. Furthermore, the view angle characteristics of the vertically aligned liquid crystal layer in the transmissive region can be optically compensated by adding the phase difference value within the XY plane and in the Z-axis direction of the sixth retardation film ((nx6+ny6)/2−nz6)×d6 to the range of an aspect of the present invention. It is also possible to optically compensate the view angle characteristics of the vertically aligned liquid crystal layer in the transmissive region by defining the phase difference value of the second retardation film and the phase difference value of the sixth retardation film as the range of an aspect of the present invention. The second retardation film may be constructed using a plurality of optical films. The fifth retardation film may be constructed using a plurality of optical films. In this case, any number of films may be used as long as the total number of films satisfies the range of the present invention. Here, the phase difference value Rt of the liquid crystal layer is represented as the integrated value Δn×d when the thickness of the liquid crystal layer is denoted by d and the refractive index anisotropy of the liquid crystal is denoted by Δn.

The liquid crystal display device according to an aspect of the present invention is characterized in that, if the refractive indexes of the first retardation film and the second retardation film in the direction of the X-axis, which is one direction in the plane perpendicular to the direction of their thickness (Z-axis) are denoted by nx1 and nx2, respectively, the refractive indexes thereof in the direction of the Y-axis, which is the direction perpendicular to the Z-axis and the X-axis are denoted by ny1, ny2 (nx1>ny1, nx2>ny2), and the thicknesses thereof in the Z-axis direction are denoted by d1 and d2, respectively, then the X-axis of the first retardation film and the X-axis of the second retardation film are orthogonal to each other, and (nx1−ny1)×d1=(nx2−ny2)×d2.

With the above arrangement, the phase difference values of the first retardation film and the second retardation film in the panel plane (XY plane) of the liquid crystal display device can be mutually cancelled, making it possible to achieve the black display (the transmission axis of the first polarizer and the transmission axis of the second polarizer being orthogonalized) and white display (the transmission axis of the first polarizer and the transmission axis of the second polarizer being parallel) that can be realized to the utmost extent by the first polarizer and the second polarizer.

The liquid crystal display device according to an aspect of the present invention is characterized in that, if the refractive indexes of the first retardation film and the fourth retardation film in the direction of the X-axis, which is one direction in the plane perpendicular to the direction of their thickness (Z-axis), are denoted by nx1 and nx4, respectively, the refractive indexes thereof in the direction of the Y-axis, which is the direction perpendicular to the Z-axis and the X-axis are denoted by ny1, ny4 (nx1>ny1, nx4>ny4), and the thicknesses thereof in the Z-axis direction are denoted by d1 and d4, then the X-axis of the first retardation film and the X-axis of the fourth retardation film are orthogonal to each other, and (nx1−ny1)×d1=(nx4−ny4)×d4.

With the above arrangement, the phase difference values of the first retardation film and the fourth retardation film in the panel plane (XY plane) of the liquid crystal display device can be mutually cancelled, making it possible to achieve the black display (the transmission axis of the first polarizer and the transmission axis of the second polarizer being orthogonalized) and white display (the transmission axis of the first polarizer and the transmission axis of the second polarizer being parallel) that can be realized to the utmost extent by the first polarizer and the second polarizer.

The liquid crystal display device according to an aspect of the present invention is characterized in that, if the refractive indexes of the second retardation film and the sixth retardation film in the direction of the X-axis, which is one direction in the plane perpendicular to the direction of their thickness (Z-axis), are denoted by nx2 and ny6, respectively, the refractive indexes thereof in the direction of the Y-axis, which is the direction perpendicular to the Z-axis and the X-axis, are denoted by ny2, ny6 (nx2>ny2, nx6>ny6), and the thicknesses thereof in the Z-axis direction are denoted by d2 and d6, respectively, then the X-axis of the second retardation film and the X-axis of the sixth retardation film are orthogonal to each other, and (nx2−ny2)×d2=(nx6−ny6)×d6. 100381 With the above arrangement, the phase difference values of the second retardation film and the sixth retardation film in the panel plane (XY plane) of the liquid crystal display device can be mutually cancelled, making it possible to achieve the black display (the transmission axis of the first polarizer and the transmission axis of the second polarizer being orthogonalized) and white display (the transmission axis of the first polarizer and the transmission axis of the second polarizer being parallel) that can be realized to the utmost extent by the first polarizer and the second polarizer.

The liquid crystal display device according to an aspect of the present invention is characterized in that the first retardation film and the second retardation film are expressed by 100 nm≦(nx1−ny1)×d1=(nx2−ny2)×d2≦160 nm.

With the above arrangement, circularly or elliptically polarized light can be produced by the first polarizer and the first retardation film, and circularly or elliptically polarized light can be produced by the second polarizer and the second retardation film. Thus, the switching of the liquid crystal display device can be accomplished by using circularly or elliptically polarized light, enabling reflective display and transmissive display with high contrast to be achieved.

The liquid crystal display device according to an aspect of the present invention is characterized in that the first retardation film and the fourth retardation film are expressed by 100 nm≦(nx1−ny1)×d1=(nx4−ny4)×d4≦160 nm.

With the above arrangement, circularly or elliptically polarized light can be produced by the first polarizer and the first retardation film, and circularly or elliptically polarized light can be produced by the second polarizer and the fourth retardation film. Thus, the switching of the liquid crystal display device can be accomplished by using circularly or elliptically polarized light, enabling reflective display and transmissive display with high contrast to be achieved.

The liquid crystal display device according to an aspect of the present invention is characterized in that the second retardation film and the sixth retardation film are expressed by 100 nm≦(nx2−ny2)×d2=(nx6−ny6)×d6≦160 nm.

With the above arrangement, circularly or elliptically polarized light can be produced by the first polarizer and the sixth retardation film, and circularly or elliptically polarized light can be produced by the second polarizer and the second retardation film. Thus, the switching of the liquid crystal display device can be accomplished by using circularly or elliptically polarized light, enabling reflective display and transmissive display with high contrast to be achieved.

The liquid crystal display device according to an aspect of the present invention is characterized in that the ratio R(450)/R(590) of an in-plane phase difference value R (450) of 450 nm to an in-plane phase difference value R (590) of 590 nm in at least one of the first retardation film, the second retardation film, the fourth retardation film and the sixth retardation film is smaller than 1.

With this arrangement, circularly polarized light of a broad spectrum with controlled wavelength dispersion can be achieved by combining the retardation film with the first polarizer or the second polarizer. This makes is possible to accomplish reflective display and transmissive display with high contrast that does not exhibit unwanted coloring.

The liquid crystal display device according to an aspect of the present invention is characterized in that the transmission axis of the first polarizer and the transmission axis of the second polarizer are orthogonal to each other.

With this arrangement, best black display implementable by the first polarizer and the second polarizer can be achieved. Thus, transmissive display with high contrast can be realized.

The liquid crystal display device according to an aspect of the present invention is characterized in that the phase difference value within the XY plane and in the Z-axis direction in the first retardation film ((nx1+ny1)/2−nz1)×d1 is substantially equal to the phase difference value in the second retardation film ((nx2+ny2)/2−nz2)×d2.

With this arrangement, the view angle when the liquid crystal layer in the reflective region is observed aslant can be compensated by the first retardation film exhibiting optical biaxiality, and the view angle when the liquid crystal layer in the transmissive region is observed aslant can be compensated by the first retardation film and the second retardation film exhibiting optical biaxiality. Light passes through the liquid crystal layer twice in the reflective region, while it passes through the liquid crystal layer only once in the transmissive region, so that the thickness of the liquid crystal layer in the transmissive region is substantially double that of the reflective region. For this reason, it is required to set the phase difference value in the first retardation film and the phase difference value within the XY plane and in the Z-axis direction in the second retardation film to be substantially equal.

The liquid crystal display device according to an aspect of the present invention is characterized in that the phase difference value within the XY plane and in the Z-axis direction in the first retardation film ((nx1+ny1)/2−nz1)×d1 is substantially equal to the phase difference value in the third retardation film ((nx3+ny3)/2−nz3)×d3.

With this arrangement, the view angle when the liquid crystal layer in the reflective region is observed aslant can be compensated by the first retardation film exhibiting optical biaxiality, and the view angle when the liquid crystal layer in the transmissive region is observed aslant can be compensated by the first retardation film exhibiting optical biaxiality and the third retardation film exhibiting optically negative uniaxiality. Light passes through the liquid crystal layer twice in the reflective region, while it passes through the liquid crystal layer only once in the transmissive region, so that the thickness of the liquid crystal layer in the transmissive region is substantially double that of the reflective region. For this reason, it is required to set the phase difference value within the XY plane and in the Z-axis direction in the first retardation film and the phase difference value within the XY plane and in the Z-axis direction in the third retardation film to be substantially equal.

The liquid crystal display device according to an aspect of the present invention is characterized in that the phase difference value within the XY plane and in the Z-axis direction in the fifth retardation film ((nx5+ny5)/2−nz5)×d5 is substantially equal to the phase difference value in the second retardation film ((nx2+ny2)/2−nz2)×d2.

With this arrangement, the view angle when the liquid crystal layer in the reflective region is observed aslant can be compensated by the fifth retardation film exhibiting optically negative uniaxiality, and the view angle when the liquid crystal layer in the transmissive region is observed aslant can be compensated by the fifth retardation film exhibiting optically negative uniaxiality and the second retardation film exhibiting optical biaxiality. Light passes through the liquid crystal layer twice in the reflective region, while it passes through the liquid crystal layer only once in the transmissive region, so that the thickness of the liquid crystal layer in the transmissive region is substantially double that of the reflective region. For this reason, it is required to set the phase difference value within the XY plane and in the Z-axis direction in the fifth retardation film and the phase difference value within the XY plane and in the Z-axis direction in the second retardation film to be substantially equal.

The liquid crystal display device according to an aspect of the present invention is characterized in that, if the refractive index of the first retardation film in the direction of the Z.-axis, which is the direction of their thickness, is denoted by nz1, the refractive index thereof in the direction of the X-axis, which is one direction in the plane perpendicular to the Z-axis, is noted as nx1, and the refractive index thereof in the direction of the Y-axis, which is the direction perpendicular to the Z-axis and the X-axis, is denoted by ny1, and the thickness thereof in the Z-axis direction is denoted byd1, then nx1>ny1>nz1 holds, and the phase difference value within the XY plane and in the Z-axis direction in the first retardation film ((nx1+ny1)/2−nz1)×d1 is 0.5×Rr≦(nx1+ny1)/2−nz1)×d1≦0.75×Rr when the phase difference value in the liquid crystal layer in the reflective region is denoted by Rr.

With this arrangement, the view angle when the liquid crystal layer in the reflective region is observed aslant can be compensated by the first retardation film exhibiting optical biaxiality.

The liquid crystal display device according to an aspect of the present invention is characterized in that, if the refractive index of the fifth retardation film in the direction of the Z-axis, which is the direction of their thickness, is denoted by nz5, the refractive index thereof in the direction of the X-axis, which is one-direction in the plane perpendicular to the Z-axis is noted as nx5, and the refractive index thereof in the direction of the Y-axis, which is the direction perpendicular to the Z-axis and the-X-axis, is denoted by ny5, and the thickness thereof in the Z-axis direction is denoted by d5, then nx5≈ny5>nz5 holds, and the phase difference value within the XY plane and in the Z-axis direction of the fifth retardation film ((nx5+ny5)/2nz5)×d5 is 0.5×Rr≦(nx5+ny5)/2−nz5)×d5≦0.75×Rr when the phase difference value in the liquid crystal layer in the reflective region is denoted by Rr.

The liquid crystal display device according to an aspect of the present invention is characterized in that, if the refractive indexes of the fifth retardation film and the sixth retardation film in the direction of the Z-axis, which is the direction of their thickness, are denoted by nz5 and nz6, respectively, the refractive indexes thereof in the direction of the X-axis, which is one direction in the plane perpendicular to Z-axis, are denoted by nx5 and nx6, respectively, the refractive indexes thereof in the direction of the Y-axis, which is the direction perpendicular to the Z-axis and the X-axis, are denoted by ny5 and ny6, respectively, and the thicknesses thereof in the Z-axis direction are denoted by d5 and d6, respectively, then nx5≈ny5>nz5 and nx6>ny6≈nz6 hold, and a sum W4 of the phase difference value within the XY plane and in the Z-axis direction of the fifth retardation film ((nx5+ny5)/2−nz5)×d5, and the phase difference value within the XY plane and in the Z-axis direction of the sixth retardation film ((nx6+ny6)/2−nz6)×d6 is expressed as 0.5×Rr≦W4≦0.75×Rr if the phase difference value in the liquid crystal layer in the reflective region is denoted by Rr.

With the arrangements described above, the view angle when the liquid crystal layer in the reflective region is observed aslant can be compensated by the fifth retardation film exhibiting optically negative uniaxiality. Furthermore, the view angle when the liquid crystal layer in the reflective region is observed aslant can be compensated by adding the sixth retardation film exhibiting optically positive uniaxiality.

The liquid crystal display device according to an aspect of the present invention is characterized in that a reflection layer capable of reflecting incident light is formed in the reflective display region.

With this arrangement, external light can be reflected by the reflective layer, permitting reflective display to be realized.

The liquid crystal display device according to an aspect of the present invention is characterized in that the reflection layer has an irregular configuration capable of performing scattered reflection of incident light.

With this arrangement, incident light is reflected in a scattered fashion by the reflective layer having the irregular configuration, permitting reflective display to be observed with wide view angle.

The liquid crystal display device according to an aspect of the present invention is characterized in that the first retardation film and the second retardation film are orthogonal to each other in the X-axis direction, and the first retardation film and the second retardation film form a substantially 45-degree angle with respect to the transmission axis of the first polarizer and the transmission axis of the second polarizer in the X-axis direction.

With the above arrangement, the phase difference values of the first retardation film and the second retardation film in the panel plane (XY plane) of the liquid crystal display device can be mutually cancelled, making it possible to achieve the black display that can be realized to the utmost extent by the first polarizer and the second polarizer. Moreover, circularly polarized light can be produced by the first polarizer and the first retardation film and the second polarizer and the second retardation film. This permits the switching of the liquid crystal display device to be accomplished by using the circularly polarized light, making it possible to realize bright reflective display and transmissive display with high contrast.

The liquid crystal display device according to an aspect of the present invention is characterized in that the first retardation film and the fourth retardation film are orthogonal to each other in the X-axis direction, and the first retardation film and the fourth retardation film form a substantially 45-degree angle with respect to the transmission axis of the first polarizer and the transmission axis of the second polarizer in the X-axis direction.

With the above arrangement, the phase difference values of the first retardation film and the fourth retardation film in the panel plane (XY plane) of the liquid crystal display device can be mutually cancelled, making it possible to achieve the black display that can be realized to the utmost extent by the first polarizer and the second polarizer. Moreover, circularly polarized light can be produced by the first polarizer and the first retardation film and the second polarizer and the fourth retardation film. This permits the switching of the liquid crystal display device to be accomplished by using the circularly polarized light, making it possible to realize bright reflective display and transmissive display with high contrast.

The liquid crystal display device according to an aspect of the present invention is characterized in that the second retardation film and the sixth retardation film are orthogonal to each other in the X-axis direction, and the second retardation film and the sixth retardation film form a substantially 45-degree angle with respect to the transmission axis of the first polarizer and the transmission axis of the second polarizer.in the X-axis direction.

With this arrangement, the phase difference values of the second retardation film and the sixth retardation film in the panel plane (XY plane) of the liquid crystal display device can be mutually cancelled, making it possible to achieve the black display that can be realized to the utmost extent by the first polarizer and the second polarizer. Moreover, circularly polarized light can be produced by the first polarizer and the sixth retardation film and the second polarizer and the second retardation film. This permits the switching of the liquid crystal display device to be accomplished by using the circularly polarized light, making it possible to realize bright reflective display and transmissive display with high contrast.

The liquid crystal display device according to an aspect of the present invention is characterized in that the inner surface of at least either the first substrate or the second substrate, the inner surface being adjacent to the liquid crystal layer, is provided with an electrode having an opening for driving the liquid crystal.

With this arrangement, the opening of the electrode to drive the liquid crystal produces a diagonal electric field in the liquid crystal layer, so that a plurality of directions of directors of liquid crystal molecules when voltage is applied can be produced in one dot. This makes it possible to accomplish a transflective liquid crystal display device with wide view angles.

The liquid crystal display device according to an aspect of the present invention is characterized in that a protuberance is formed on the electrode formed on the inner surface of at least either the first substrate or the second substrate, the surface being adjacent to the liquid crystal layer.

With this arrangement, the direction in which liquid crystal molecules fall can be controlled by the protuberance formed on the electrode. Hence, a plurality of directions of directors of liquid crystal molecules when voltage is applied can be produced in one dot. This makes it possible to accomplish a transflective liquid crystal display device with wide view angles.

The liquid crystal display device according to an aspect of the present invention is characterized in that there are at least two liquid crystal directors in one dot when the liquid crystal is driven by the electrode.

This arrangement makes it possible to realize a transflective liquid crystal display device with wide view angles.

Electronic equipment in accordance with an aspect of the present invention is characterized by being equipped with the aforesaid transflective liquid crystal display device.

This arrangement makes it possible to realize electronic equipment incorporating a display device with high visibility.

### BRIEF DESCRIPTION OF THE DRAWINGS

FIG. 1 is a schematic showing a partial sectional structure of a liquid crystal display device according to a first exemplary embodiment of the present invention;

FIG. 2 is a schematic showing a partial sectional structure of a liquid crystal display device according to a second exemplary embodiment of the present invention;

FIG. 3 is a schematic showing a partial sectional structure of a liquid crystal display device according to a third exemplary embodiment of the present invention;

FIG. 4 is a perspective view showing an example of the electronic equipment according to an aspect of the present invention;

FIG. 5 is a perspective view showing an example of the electronic equipment according to an aspect of the present invention;

FIG. 6 is a perspective view showing an example of the electronic equipment according to an aspect of the present invention;

FIG. 7 is a schematic showing the relationship between W1/Rt values and transmissive display view angle range of a liquid crystal display device according to the first exemplary embodiment of the present invention;

FIG. 8 is a schematic showing the relationship between W2/Rt values and transmissive display view angle range of a liquid crystal display device according to the second exemplary embodiment of the present invention;

FIG. 9 is a schematic showing the relationship between W3/Rt values and transmissive display view angle range of a liquid crystal display device according to the third exemplary embodiment of the present invention;

FIG. 10 is a schematic showing the relationship between W4/Rr values and reflective display view angle range of the liquid crystal display device according to an aspect of the present invention;

FIG. 11 is a schematic showing the relationship between the brightness of a backlight and polar angles;

FIG. 12 is an explanatory schematic of the compensational operation of view angle characteristics.

### DETAILED DESCRIPTION OF PREFERRED EMBODIMENTS

Exemplary embodiments of the present invention will be explained in conjunction with the accompanying figures.

First Exemplary Embodiment

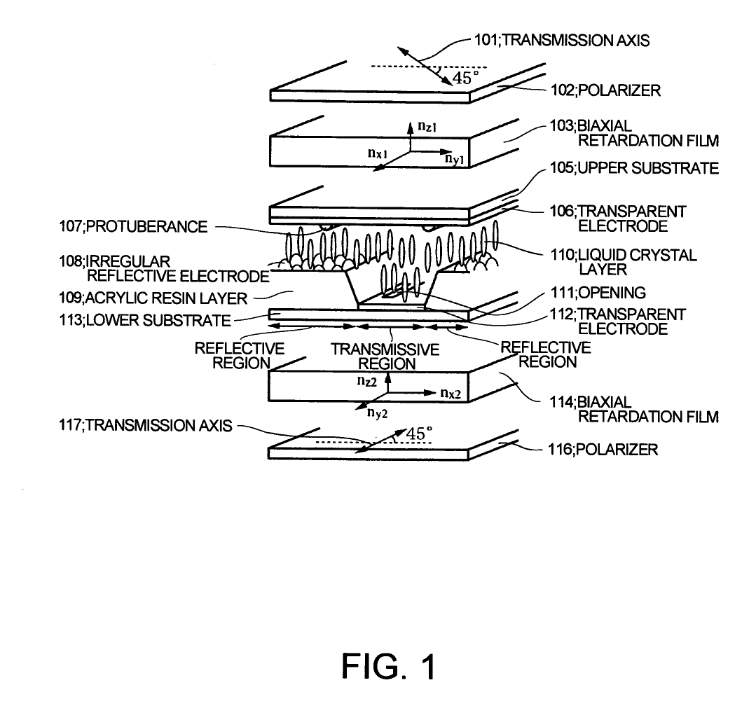

FIG. 1 shows a first exemplary embodiment in which the construction in accordance with the present invention has been applied to an active matrix type liquid crystal display device. As shown by the sectional structure illustrated in FIG. 1, the liquid crystal display device according to the first exemplary embodiment has a basic structure wherein a liquid crystal layer 110 is sandwiched between substrates 105 and 113 composed of transparent glass or the like and disposed such that they vertically face each other. Although not shown in the drawing, a sealant is actually provided adjacently to the peripheral portions of the substrates 105 and 113. The liquid crystal layer 110 is surrounded by the substrates 105, 113 and the sealant so as to be sandwiched in a sealed state between the substrates 105 and 113. A backlight equipped with a light source, an optical waveguide, etc. is provided further below the lower substrate 113, although the backlight is not shown in FIG. 1.

A retardation film 103 and a polarizer 102 are disposed on the upper surface side (observer's side) of the upper substrate 105, while a retardation film 114 and a polarizer 116 are also disposed on the bottom surface side of the lower substrate 113. The polarizers 102 and 116 allow passage of only linearly polarized light in one direction out of external light entering through their upper surfaces and the light of the backlight entering through their bottom surfaces. The retardation films 103 and 114 convert the linearly polarized light that has passed through the polarizers 102 and 116 into circularly polarized light (including elliptically polarized light). Thus, the polarizers 102, 116 and the retardation films 103, 114 function as a circularly polarized light entrance device. In this exemplary embodiment, the side provided with the backlight is defined as the lower side, while the side where external light is entered is defined as the upper side. The substrate 105 may be referred to as the upper substrate, while the substrate 113 may be referred to as the lower substrate.

Furthermore, a transparent electrode 106 composed of ITO (Indium-Tin-Oxide), or the like is formed on the surface of the upper substrate 105 adjacent to the liquid crystal layer 110, and a perpendicularly aligned layer (not shown in the drawing), which covers the transparent electrode 106, is formed on the surface of the transparent electrode 106 adjacent to the liquid crystal layer 110. A reflective electrode 108 serving also as a reflective layer and a transparent electrode 112 are formed on the surface of the lower substrate 113 adjacent to the liquid crystal layer 110, the reflective electrode 108 functioning as a reflective display region, while the transparent electrode 112 functioning as a transmissive display region. The reflective electrode 108 is formed of light reflective metal materials, such as Al or Ag, with high reflectivity, and has a rectangular frame shape in a plan view. The reflective electrode 108 has a perpendicularly aligned layer (not shown in the figure) formed on the surface thereof adjacent to the liquid crystal layer 110.

A resin layer 109 formed of an acrylic material provides the irregular surface of the reflective electrode 108 and makes the thickness of the liquid crystal layer in the reflective display region smaller than the liquid crystal layer in the transmissive display region. This structure can be accomplished by photolithography. In this exemplary embodiment, the reflective layer of the reflective display region serves also as the liquid crystal driving electrode; however, they may be separately provided. It is possible to form micro concavities and convexities by the photolithographic process in which a resist is applied onto the glass substrate that provides the lower substrate 113, then the substrate is etched using hydrofluoric acid, and the resist is peeled off after the etching. The reflective layer with the irregular surface can be created by forming a reflective layer on the aforesaid micro concavities and convexities.

Dielectric protuberances 107 composed of an acrylic resin are formed on the transparent electrode 106 formed on the inner surface of the upper substrate 105, a slant electric field not orthogonalized to an opening 111 of the transparent electrode 112 formed on the inner surface of the lower substrate 113 and the surfaces of the substrates 105 and 113 is applied to the liquid crystal layer 110. Forming the dielectric protuberance 107 and the opening 111 of the transparent electrode 112 makes it possible to create a plurality of directors of the liquid crystal layer 110 in one dot when voltage is applied to the electrodes 106, 108 and 112. This allows a liquid crystal display device not dependent upon view angles to be realized.

Although not shown in FIG. 1, a thin film transistor functioning as a switching element to drive the electrodes 108 and 112 is formed in the comer portion around each dot, and a gate line and a source line to supply power to the thin film transistor are provided. The switching element may be a two-terminal linear element in place of the thin film transistor, or may have another structure.

The operation and effect of the transflective liquid crystal display device having the structure shown in FIG. 1 will now be explained. To perform reflective display, the light entering from outer side of the device is used, and the incident light is guided toward the liquid crystal layer 110 via the polarizer 102, the retardation film 103, the upper substrate 105 and the electrode 106.

In the reflective display region, the incident light passes through the liquid crystal layer 110 and is reflected by the reflective electrode 108. The reflected light then passes through the liquid crystal layer 110 again and returned to the outside of the device through the electrode 106, the upper substrate 105, the retardation film 103 and the polarizer 102, thus reaching an observer to accomplish the reflective display. In this type of reflective display, the liquid crystal of the liquid crystal layer 110 is alignment-controlled by the electrodes 106 and 108 to change the polarized state of light passing through the liquid crystal layer 110 so as to perform contrast-based display.

To perform transmissive display, the light emitted from the backlight (illuminating device) enters via the polarizer 116, the retardation film 114 and the substrate 113. In this case, the light incident upon the substrate 113 passes through the electrode 112, the liquid crystal layer 110, the electrode 106, the substrate 105, the retardation film 103 and the polarizer 102 in this order to accomplish the transmissive display in the transmissive display region. In this type of transmissive display also, it is possible to control the alignment of the liquid crystal of the liquid crystal layer 110 by the electrodes 106 and 112 to change the polarized state of the light passing through the liquid crystal layer 110 so as to accomplish contrast-based display.

Of these display modes, incident light passes through the liquid crystal layer 110 twice in the reflective display mode. Regarding transmitted light, the light emitted from the backlight (illuminating device) passes through the liquid crystal layer 110 only once. When the retardation (phase difference value) of the liquid crystal layer 110 is considered, if the alignment control is carried out by applying the same voltage through the electrodes, then the state of transmissivity of the liquid crystal differs between the reflective display mode and the transmissive display mode due to their different retardations. According to the structure of the exemplary embodiment, however, the region wherein the reflective display is performed that is the reflective display region provided with the reflective electrode 108 shown in FIG. 1 has a liquid crystal layer thickness control layer 109 formed of an acrylic resin. Hence, the thickness of the liquid crystal layer 110 in the transmissive display region to perform transmissive display is greater than the thickness of the liquid crystal layer 110 in the reflective display region. This makes it possible to optimize the state related to the transmissive display and the reflective display of the liquid. crystal layer 110 in the reflective display region and the transmissive display region, i.e., the distance over which light travels when passing through the liquid crystal layer 110 in each region. Accordingly, forming the liquid crystal layer thickness control layer 109 composed of an acrylic resin allows the retardation in the reflective display region and the transmissive display region to be optimized, so that bright display with high contrast can be obtained both in the reflective display mode and the transmissive display mode.

The retardation film 103 exhibits biaxiality (nx1>ny1>nz1), the phase difference value in its XY plane is about 140 nm, and an X-axis of the retardation film 103 forms about 45-degree angle with respect to a transmission axis 101 of the polarizer 102. The retardation film 114 exhibits biaxiality (nx2>ny2>nz2), the phase difference value in an XY plane is about 140 nm, and an X-axis of the retardation film 114 forms about 45-degree angle with respect to a transmission axis 117 of the polarizer 116. The transmission axis 101 of the polarizer 102 and the transmission axis 117 of the polarizer 116 are orthogonal to each other, and the X-axis of the retardation film 103 and the X-axis of the retardation film 114 are also orthogonal to each other. Furthermore, setting the phase difference value of the retardation film 103 equal to the phase difference value of the retardation film 114 makes it possible to bring the value of the phase difference between the polarizers 102 and 116 to zero in a non-drive state, thus allowing ideal black display to be achieved.

The retardation film 103 exhibits biaxiality (nx1>ny1>nz1) and has an average phase difference of about 120 nm between the XY plane and the Z-axis direction. The retardation film 114 exhibits biaxiality (nx2>ny2>nz2) and has an average phase difference of about 120 nm in the XY plane and in the Z-axis direction. In this exemplary embodiment, the phase difference value in the transmissive region in the liquid crystal layer 110 is 380 nm, while the phase difference value in the reflective region is 200 nm. Disposing the retardation films 103 and 114 makes it possible to compensate the phase difference in the liquid crystal layer 110 that is produced when observed aslant.

FIG. 12 is a schematic representation illustrating the compensating operation related to the view angle characteristics. A light beam 10 emitted aslant from a backlight (not shown) passes through the second retardation film 114, the liquid crystal layer 110 and the first retardation film 103 before reaching an observer (not shown). In the liquid crystal layer 110, a liquid crystal molecule 110a is vertically oriented, so that the phase difference in the XY plane of the liquid crystal layer 110 is substantially zero. The sum of the phase difference of the first retardation film 103 and the second retardation film 114 in the XY plane is substantially zero, as discussed above. Hence, the light beam 10 does not cause a phase difference in the vertical direction. If, however, the light enters at an angle, then a phase difference results in the Z-axis direction. Thus, the phase difference in the liquid crystal layer 110 that takes place when observed aslant can be compensated by disposing the retardation films 103 and 114.

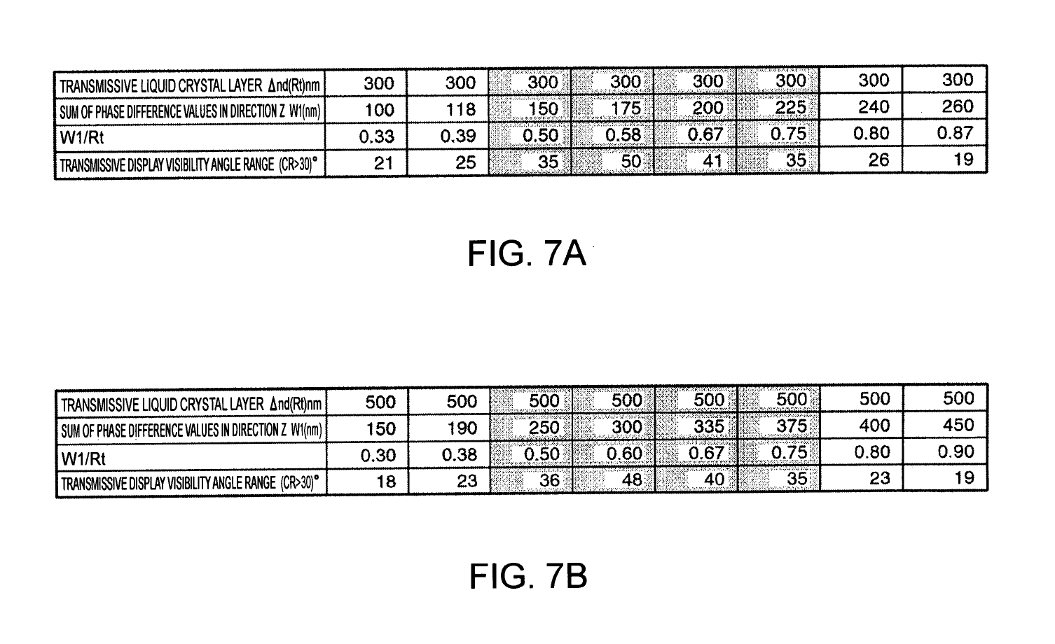

FIG. 7 shows the relationship between W1/Rt values and transmissive display view angle range. FIG. 7(a) shows a case where the phase difference value Rt in the transmissive region is 300 run, and FIG. 7(b) shows a case where the phase difference value Rt in the transmissive region is 500 nm. A sum WI of the phase differences in the Z-axis direction is the total of the phase difference value within the XY plane and in the Z-axis direction in the first retardation film 103 ((nx1+ny1)/2−nz1)×d1 and the phase difference value within the XY plane and in the Z-axis direction in the second retardation film 114 ((nx2+ny2)/2−nz²)×d2. The transmissive display view angle range indicates the view angle range in which high contrast of 30 or more can be obtained. As shown in FIG. 7, the transmissive display view angle range takes a maximal value in the vicinity of W1/Rt=0.58.

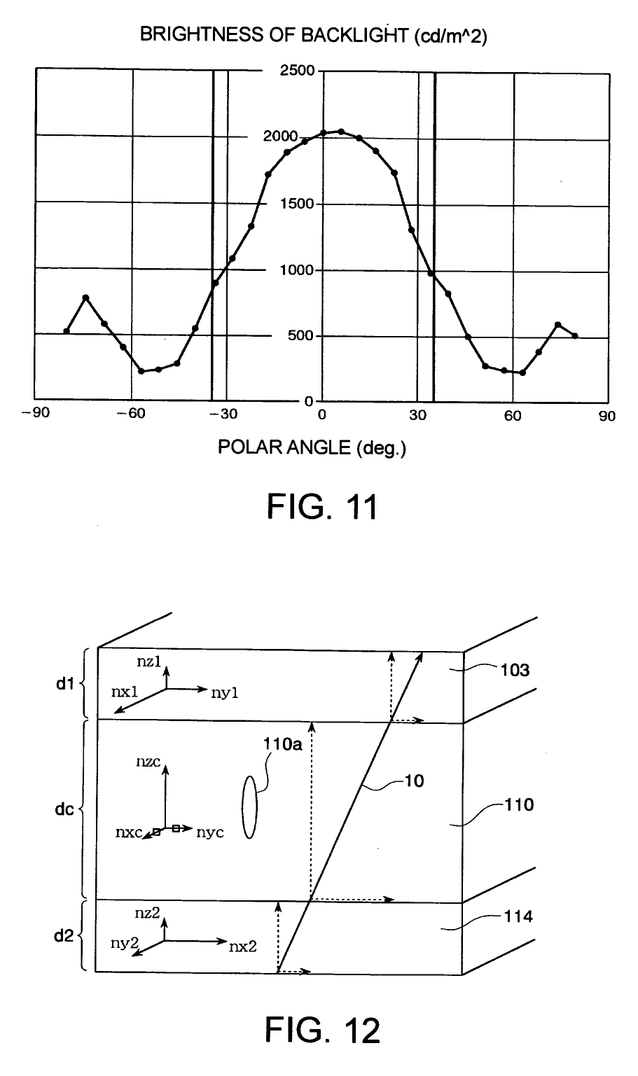

FIG. 11 is a graph showing the relationship between the brightness of a backlight and polar angles in a general liquid crystal display device of a portable telephone or the like. If the polar angle is 0 degree, that is, the display surface of the liquid crystal display device is viewed from a perpendicular direction, the maximum brightness of the backlight is reached. High brightness of the backlight (about 1000 cd/m² or more) is obtained in the range of polar angle of ±35°. Referring to FIG. 7, the transmissive display view angle range reaches 35° or more in the range of 0.5≦W1/Rt≦0.75. Accordingly, each retardation film is set to satisfy the condition of 0.5≦W1/Rt≦0.75 so as to make it possible to secure high contrast at the high brightness range or more of the backlight in the transmissive region.

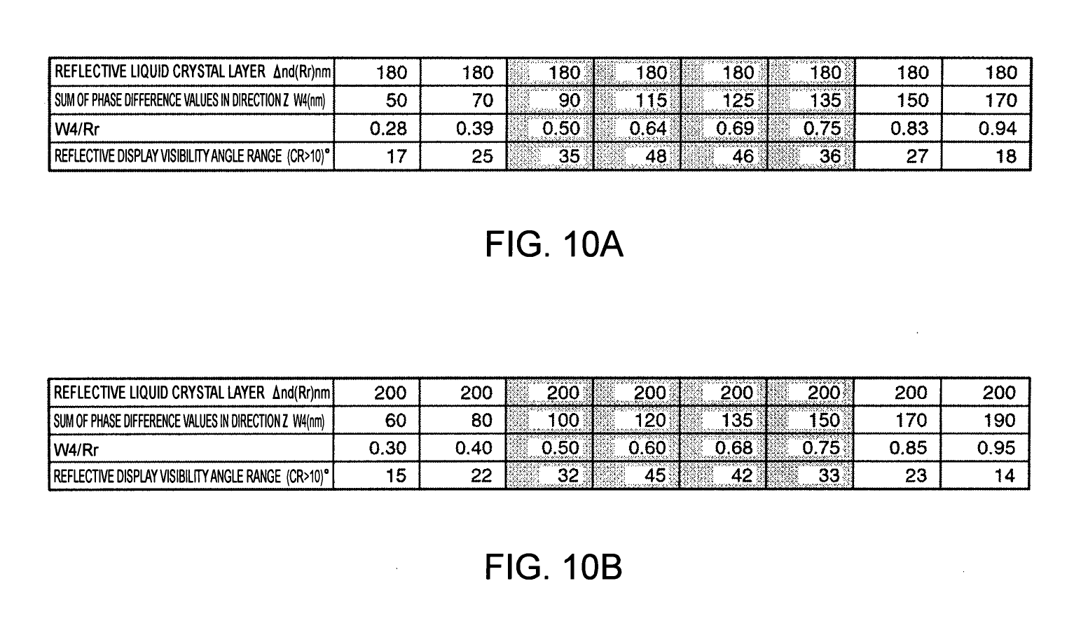

FIG. 10(a) shows the relationship between the W4/Rr values and reflective display view angle range. FIG. 10(a) shows a case where the phase difference value Rr in the reflective region is 180 nm. A sum W4 of the values of the phase differences in the Z-axis direction is the total of the phase difference value within the XY plane and in the Z-axis direction in the first retardation film 103 ((nx1+ny1)/2−nz1)×d1. The transmissive display view angle range indicates the view angle range in which high contrast of 10 or more can be obtained. The view angle range of a related art STN mode liquid crystal display device is about 30°. In FIG. 10(a), the transmissive display view angle range reaches 30° or more in the range defined by 0.5≦W4/Rr≦0.75. Thus, setting each retardation film to satisfy the condition of 0.5≦W4/Rr≦0.75 makes it possible to secure high contrast in the view angle range or more of the conventional STN mode liquid crystal display device in the reflective region.

The retardation film 103 and 114 may be constructed of a plurality of laminated optical films. The ratio R (450)/R(590) of the phase difference value R (450) in the XY plane at 450 nm to the phase difference value R (590) in the XY plane at 590 nm in the retardation films 103 and 114 is preferably smaller than 1. This makes it possible to create substantially circularly polarized light in a visible light range.

As set forth above, the liquid crystal display device according to the first exemplary embodiment is capable of achieving display with higher contrast and wider view angles. Furthermore, the first retardation film and the second retardation film use the optically biaxial retardation films, making it possible to achieve a thinner, less expensive liquid crystal display device, as compared with the case where a retardation film having optically positive uniaxiality and a retardation film having optically negative uniaxiality are used in combination.

Second Exemplary Embodiment

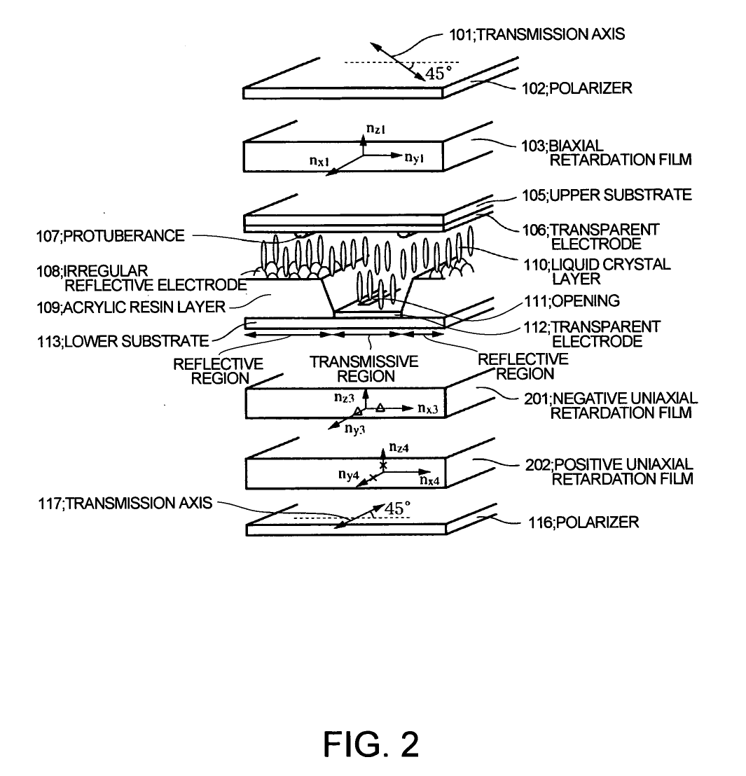

A second exemplary embodiment in accordance with an aspect of the present invention will now be explained with reference to FIG. 2. The like reference numerals as those in the first exemplary embodiment shown in FIG. 1 will denote the like components unless otherwise specified, and the description thereof will be omitted.

To perform reflective display, the light entering from outer side of the device is used, and the incident light is guided toward a liquid crystal layer 110 via a polarizer 102, a retardation film 103, an upper substrate 105 and an electrode 106. In a reflective display region, the incident light passes through the liquid crystal layer 110 and is reflected by a reflective electrode 108. The reflected light then passes through the liquid crystal layer 110 again and is returned to the outside of the device through the electrode 106, the upper substrate 105, the retardation film 103 and the polarizer 102, thus reaching an observer to accomplish the reflective display. In this type of reflective display, the liquid crystal of the liquid crystal layer 110 is alignment controlled by the electrodes 106 and 108 to change the polarized state of light passing through the liquid crystal layer 110 so as to perform contrast-based display.

To perform transmissive display, the light emitted from a backlight (illuminating device) enters via a polarizer 116, retardation films 202, 201 and a substrate 113. In this case, the light incident upon the substrate 113 passes through an electrode 112, the liquid crystal layer 110, the electrode 106, the substrate 105, the retardation film 103 and the polarizer 102 in this order to accomplish the transmissive display in the transmissive display region. In this type of transmissive display also, it is possible to control the alignment of the liquid crystal of the liquid crystal layer 110 by the electrodes 106 and 112 to change the polarized state of the light passing through the liquid crystal layer 110 so as to accomplish contrast-based display.

Of these display modes, incident light passes through the liquid crystal layer 110 twice in the reflective display mode. Regarding transmitted light, the light emitted from the backlight (illuminating device) passes through the liquid crystal layer 110 only once. When the retardation (phase difference value) of the liquid crystal layer 110 is considered, if the alignment control is carried out by applying the same voltage through the electrodes, then the state of transmissivity of the liquid crystal differs between the reflective display mode and the transmissive display mode due to their different retardations. According to the structure of the exemplary embodiment, however, the region wherein the reflective display is performed, that is, the reflective display region provided with the reflective electrode 108 shown in FIG. 2 has a liquid crystal layer thickness control layer 109 formed of an acrylic resin. Hence, the thickness of the liquid crystal layer 110 in the transmissive display region to perform transmissive display is greater than the thickness of the liquid crystal layer 110 in the reflective display region. This makes it possible to optimize the state related to the transmissive display and the reflective display of the liquid crystal layer 110 in the reflective display region and the transmissive display region, i.e., the distance over which light travels when passing through the liquid crystal layer 110 in each region. Accordingly, forming the liquid crystal layer thickness control layer 109 composed of an acrylic resin allows the retardation in the reflective display region and the transmissive display region to be optimized, so that bright display with high contrast can be obtained both in the reflective display mode and the transmissive display mode.

The retardation film 103 exhibits biaxiality (nx1>ny1>nz1), the phase difference value in its XY plane is about 140 nm, and an X-axis of the retardation film 103 forms about 45-degree angle with respect to a transmission axis 101 of the polarizer 102. The retardation film 202 exhibits positive uniaxiality (nx4>ny4≈nz4), the phase difference value in an XY plane is about 140 nm, and an X-axis of the retardation film 202 forms about 45-degree angle with respect to a transmission axis 117 of the polarizer 116. The transmission axis 101 of the polarizer 102 and the transmission axis 117 of the polarizer 116 are orthogonal to each other, and the X-axis of the retardation film 103 and the X-axis of the retardation film 202 are also orthogonal to each other. Furthermore, setting the phase difference value of the retardation film 103 equal to the phase difference value of the retardation film 202 makes it possible to bring the value of the phase difference between the polarizers 102 and 116 to zero in a non-drive state, thus allowing ideal black display to be achieved.

The retardation film 103 exhibits biaxiality (nx1>ny1>nz1) and has an average phase difference of about 110 nm between the XY plane and the Z-axis direction. The retardation film 201 exhibits negative uniaxiality (nx3≈ny3>nz3), has a substantially zero phase difference value in the XY plane, and has about 120 nm phase difference in the Z-axis direction. Here, the phase difference value in the transmissive region in the liquid crystal layer 110 is 380 nm. Disposing the retardation film 103 makes it possible to compensate the phase difference in the liquid crystal layer 110 developed when the reflective display is observed aslant. Disposing the retardation films 103 and 201 makes it possible to compensate the phase difference in the liquid crystal layer 110 developed when the transmissive display is observed aslant.

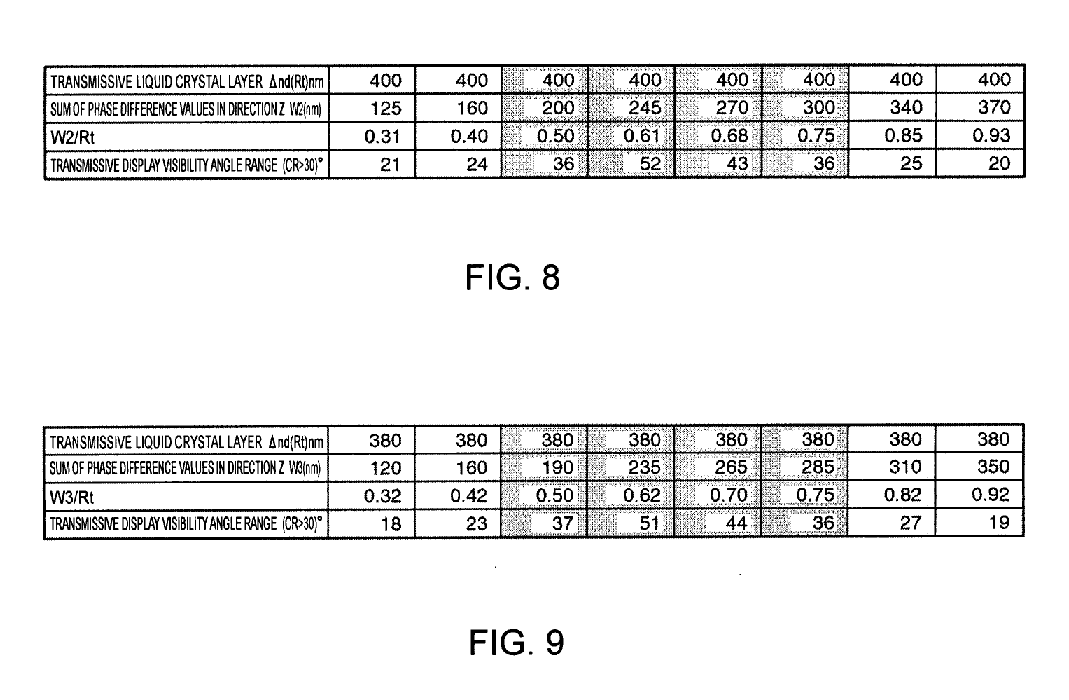

FIG. 8 shows the relationship between the W2/Rt values and transmissive display view angle range. FIG. 8 shows a case where the phase difference value Rt in the transmissive region is 400 nm. A sum W2 of the values of the phase differences in the Z-axis direction is the total of the phase difference value within the XY plane and in the Z-axis direction in the first retardation film 103 ((nx1+ny1)/2−nz1)×d1, the phase difference value within the XY plane and in the Z-axis direction in the third retardation film 201 (nx3-nz3)×d3, and the phase difference value within the XY plane and in the Z-axis direction in the fourth retardation film 202 ((nx4+ny4)/2−nz4)×d4. The transmissive display view angle range indicates the view angle range in which high contrast of 30 or more can be obtained. As shown in FIG. 11, high brightness of the backlight (about 1000 cd/m² or more) is obtained in the range of polar angle of ±35°. Referring to FIG. 8, the transmissive display view angle range reaches 35° or more in the range of 0.5≦W2/Rt≦0.75. Accordingly, each retardation film is set to satisfy the condition of 0.5≦W2/Rt≦0.75 so as to make it possible to secure high contrast at the high brightness range or more of the backlight in the transmissive region.

As set forth above, the liquid crystal display device according to the second exemplary embodiment is capable of achieving display with higher contrast and wider view angles.

Third Exemplary Embodiment

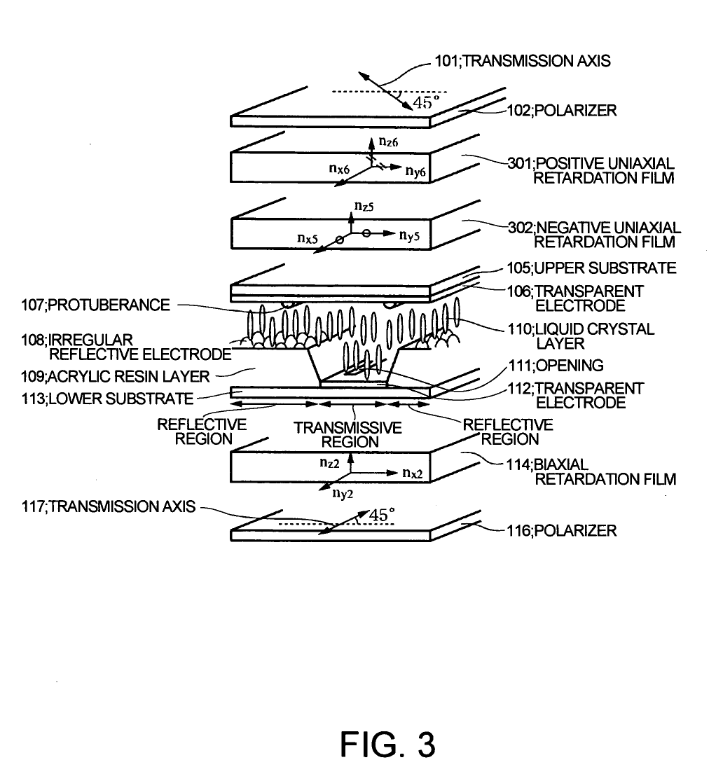

A third exemplary embodiment in accordance with the present invention will now be explained with reference to FIG. 3. The like reference numerals as those in the first exemplary embodiment shown in FIG. 1 will denote the like components unless otherwise specified, and the description thereof will be omitted.

To perform reflective display, the light entering from outer side of the device is used, and the incident light is guided toward a liquid crystal layer 110 via a polarizer 102, retardation films 301 and 302, an upper substrate 105 and an electrode 106. In a reflective display region, the incident light passes through the liquid crystal layer 110 and is reflected by a reflective electrode 108. The reflected light then passes through the liquid crystal layer 110 again and is returned to the outside of the device through the electrode 106, the upper substrate 105, the retardation films 302 and 301, and the polarizer 102, thus reaching an observer to accomplish the reflective display. In this type of reflective display, the liquid crystal of the liquid crystal layer 110 is alignment-controlled by the electrodes 106 and 108 to change the polarized state of light passing through the liquid crystal layer 110 so as to perform contrast-based display.

To perform transmissive display, the light emitted from a backlight (illuminating device) enters via a polarizer 116, a retardation film 114 and a substrate 113. In this case, the light incident upon the substrate 113 passes through an electrode 112, the liquid crystal layer 110, the electrode 106, the substrate 105, the retardation films 302 and 301, and the polarizer 102 in this order to accomplish the transmissive display in the transmissive display region. In this type of transmissive display also, it is possible to control the alignment of the liquid crystal of the liquid crystal layer 110 by the electrodes 106 and 112 to change the polarized state of the light passing through the liquid crystal layer 110 so as to accomplish contrast-based display.

Of these display modes, incident light passes through the liquid crystal layer 110 twice in the reflective display mode. Regarding transmitted light, the light emitted from the backlight (illuminating device) passes through the liquid crystal layer 110 only once. When the retardation (phase difference value) of the liquid crystal layer 110 is considered, if the alignment control is carried out by applying the same voltage through the electrodes, then the state of transmissivity of the liquid crystal differs between the reflective display mode and the transmissive display mode due to their different retardations. According to the structure of the exemplary embodiment, however, the region wherein the reflective display is performed, that is, the reflective display region provided with the reflective electrode 108 shown in FIG. 3 has a liquid crystal layer thickness control layer 109 formed of an acrylic resin. Hence, the thickness of the liquid crystal layer 110 in the transmissive display region to perform transmissive display is greater than the thickness of the liquid crystal layer 110 in the reflective display region. This makes it possible to optimize the state related to the transmissive display and the reflective display of the liquid crystal layer 110 in the reflective display region and the transmissive display region, i.e., the distance over which light travels when passing through the liquid crystal layer 110 in each region. Accordingly, forming the liquid crystal layer thickness control layer 109 composed of an acrylic resin allows the retardation in the reflective display region and the transmissive display region to be optimized, so that bright display with high contrast can be obtained both in the reflective display mode and the transmissive display mode.

The retardation film 301 exhibits positive uniaxiality (nx6>ny6≈nz6), the phase difference value in its XY plane is about 140 nm, and an X-axis of the retardation film 301 forms about 45-degree angle with respect to a transmission axis 101 of the polarizer 102. The retardation film 114 exhibits biaxiality (nx2>ny2>nz2), the phase difference value in an XY plane is about 140 nm, and an X-axis of the retardation film 114 forms about 45-degree angle with respect to a transmission axis 117 of the polarizer 116. A transmission axis 101 of the polarizer 102 and the transmission axis 117 of the polarizer 116 are orthogonal to each other, and the X-axis of the retardation film 301 and the X-axis of the retardation film 114 are also orthogonal to each other. Furthermore, setting the phase difference value of the retardation film 301 equal to the phase difference value in the XY plane of the retardation film 114 makes it possible to bring the value of the phase difference between the polarizers 102 and 116 to zero in a non-drive state, thus allowing ideal black display to be achieved.

The retardation film 302 exhibits negative uniaxiality (nx5≈ny5>nz5) and has an average phase difference value of about 100 nm between the XY plane and the Z-axis direction. The retardation film 114 exhibits biaxiality (nx2>ny2>nz2) and has an average phase difference value of about 240 nm between the XY plane and the Z-axis direction. Here, the phase difference value in the reflective region in the liquid crystal layer 110 is 200 nm, while the phase difference value in the transmissive region is 380 nm. Disposing the retardation film 302 makes it possible to compensate the phase difference in the liquid crystal layer 110 developed when the reflective display is observed aslant. Disposing the retardation films 302 and 114 makes it possible to compensate the phase difference in the liquid crystal layer 110 developed when the transmissive display is observed aslant.

FIG. 9 shows the relationship between the W3/Rt values and transmissive display view angle range. FIG. 9 shows a case where the phase difference value Rt in the transmissive region is 380 nm. A sum W3 of the phase differences in the Z-axis direction is the total of the phase difference value within the XY plane and in the Z-axis direction in the second retardation film 114 ((nx2+ny2)/2−nz2)×d2, the phase difference value within the XY plane and in the Z-axis direction in the fifth retardation film 302 (nx5−nz5)×d5, and the phase difference value within the XY plane and in the Z-axis direction in the sixth retardation film 301 ((nx6+ny6)/2−nz6)×d6. The transmissive display view angle range indicates the view angle range in which high contrast of 30 or more can be obtained. As shown in FIG. 11, high brightness of the backlight (about 1000 cd/m² or more) is obtained in the range of polar angle of ±35°. Referring to FIG. 9, the transmissive display view angle range reaches 35° or more in the range of 0.5≦W3/Rt≦0.75. Accordingly, each retardation film is set to satisfy the condition of 0.5≦W3/Rt≦0.75 so as to make it possible to secure high contrast at the high brightness range or more of the backlight in the transmissive region.

FIG. 10(b) shows the relationship between the W4/Rr values and reflective display view angle range. FIG. 10(b) shows a case where the phase difference value Rr in the reflective region is 200 nm. A sum W4 of the values of the phase differences in the Z-axis direction is the total of the phase difference value within the XY plane and in the Z-axis direction in the fifth retardation film 302 (nx5−nz5)×d5 and the phase difference value within the XY plane and in the Z-axis direction in the sixth retardation film 301 ((nx6+ny6)/2−nz6)×d6. The transmissive display view angle range indicates the view angle range in which high contrast of 10 or more can be obtained. The view angle range of a related art STN mode liquid crystal display device is about 30°. In FIG. 10(b), the transmissive display view angle range reaches 30° or more in the range defined by 0.5≦W4/Rr≦0.75. Thus, setting each retardation film to satisfy the condition of 0.5≦W4/Rr≦0.75 makes-it possible to secure high contrast in the view angle range or more of the related art STN mode liquid crystal display device in the reflective region.

As set forth above, the liquid crystal display device according to the third exemplary embodiment is capable of achieving display with higher contrast and wider view angles.

Fourth Exemplary Embodiment

An example of the electronic equipment provided with any one of the liquid crystal display device in the exemplary embodiments described above will be explained.

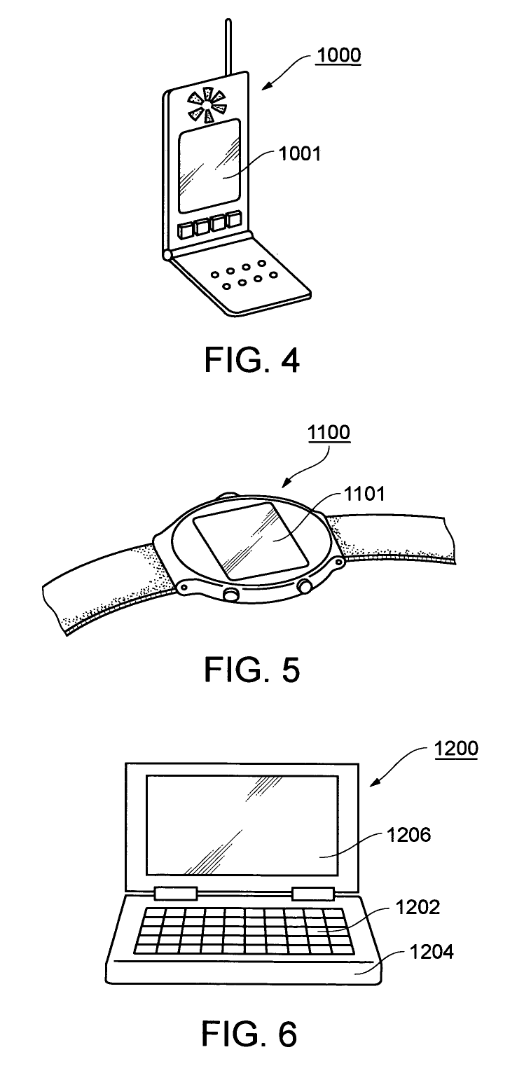

FIG. 4 is a perspective view showing an example of a portable telephone. In FIG. 4, reference numeral 1000 denotes a portable telephone main unit, and reference numeral 1001 denotes a liquid crystal display unit using the liquid crystal display device according to any one of the above first to third exemplary embodiments.

FIG. 5 is a perspective view showing an example of wristwatch type electronic equipment. In FIG. 5, reference numeral 1100 denotes a watch main unit, and reference numeral 1101 denotes a liquid crystal display unit using the liquid crystal display device according to any one of the above first to third exemplary embodiments.

FIG. 6 is a perspective view showing an example of a portable information processing apparatus, such as a word processor or a personal computer. In FIG. 6, reference numeral 1200 denotes an information processing apparatus, and reference numeral 1202 denotes an input unit, such as a keyboard, reference numeral 1204 denotes the main unit of the information processing apparatus, and reference numeral 1206 denotes a liquid crystal display unit using the liquid crystal display device according to any one of the above first to third exemplary embodiments.

Thus, the electronic equipment shown in FIG. 4 through FIG. 6 is provided with the liquid crystal display unit using the liquid crystal display device according to any one of the first to third embodiments, making it possible to realize electronic equipment having a display unit with wider view angles and higher contrast in various environments. Advantages

As explained in detail above, according to an aspect of the present invention, reflective display and transmissive display with wider view angles and higher contrast can be obtained in a transflective liquid crystal display device equipped with both reflective and transmissive structures.

What is claimed is:

1. A liquid crystal display device comprising:
a liquid crystal layer sandwiched between a first substrate and a second substrate,
one dot including a reflective display region used for reflective display and a transmissive display region used for transmissive display,
the liquid crystal layer includes a nematic liquid crystal having negative permittivity anisotropy oriented substantially perpendicularly to the substrates,
a first retardation film and a first polarizer being disposed in this order on the outer side of the first substrate,
a second retardation film, a second polarizer and an illuminating device being disposed in this order on the outer side of the second substrate, and
at least one of the first retardation film and the second retardation film having optical biaxiality.

2. A liquid crystal display device comprising:
a liquid crystal layer sandwiched between a first substrate and a second substrate,
one dot including a reflective display region used for reflective display and a transmissive display region used for transmissive display,
the liquid crystal layer including a nematic liquid crystal having negative permittivity anisotropy oriented substantially perpendicularly to the substrates,
a first retardation film having optical biaxiality and a first polarizer being disposed in this order on the outer side of the first substrate, and
a second retardation film having optical biaxiality, a second polarizer and an illuminating device being disposed in this order on the outer side of the second substrate.

3. A liquid crystal display device comprising:
a liquid crystal layer sandwiched between a first substrate and a second substrate,
one dot including a reflective display region used for reflective display and a transmissive display region used for transmissive display,
the liquid crystal layer including a nematic liquid crystal having negative permittivity anisotropy oriented substantially perpendicularly to the substrates,
a first retardation film having optical biaxiality and a first polarizer being disposed in this order on the outer side of the first substrate, and
a third retardation film having optically negative uniaxiality, a fourth retardation film having optically positive uniaxiality, a second polarizer and an illuminating device being disposed in this order on the outer side of the second substrate.

4. A liquid crystal display device comprising:
a liquid crystal layer sandwiched between a first substrate and a second substrate,
one dot including a reflective display region used for reflective display and a transmissive display region used for transmissive display,
the liquid crystal layer including a nematic liquid crystal having negative permittivity anisotropy oriented substantially perpendicularly to the substrates,
a first retardation film having optical biaxiality and a first polarizer being disposed in this order on the outer side of the first substrate, and
a fourth retardation film having optically positive uniaxiality, a second polarizer and an illuminating device being disposed in this order on the outer side of the second substrate.

5. A liquid crystal display device comprising:
a liquid crystal layer sandwiched between a first substrate and a second substrate,
one dot including a reflective display region used for reflective display and a transmissive display region used for transmissive display,
the liquid crystal layer including a nematic liquid crystal having negative permittivity anisotropy oriented substantially perpendicularly to the substrates,
a fifth retardation film having optically negative uniaxiality, a sixth retardation film having optically positive uniaxiality and a first polarizer being disposed in this order on the outer side of the first substrate, and
a second retardation film having optical biaxiality, a second polarizer and an illuminating device being disposed in this order on the outer side of the second substrate.

6. A liquid crystal display device comprising:
a liquid crystal layer sandwiched between a first substrate and a second substrate,
one dot including a reflective display region used for reflective display and a transmissive display region used for transmissive display,
the liquid crystal layer including a nematic liquid crystal having negative permittivity anisotropy oriented substantially perpendicularly to the substrates,
a sixth retardation film having optically positive uniaxiality and a first polarizer being disposed in this order on the outer side of the first substrate, and
a second retardation film having optical biaxiality, a second polarizer and an illuminating device being disposed in this order on the outer side of the second substrate.

7. The liquid crystal display device according to claim 1, the thickness of the liquid crystal layer of the reflective display region being smaller than the thickness of the liquid crystal layer of the transmissive region.

8. The liquid crystal display device according to claim 1, if the refractive indexes of the first retardation film and the second retardation film in the direction of a Z-axis, which is the direction of their thickness, are denoted by nz1 and nz2, respectively, the refractive indexes thereof in the direction of an X-axis, which is one direction in the plane perpendicular to the Z-axis, are denoted by nx1 and nx2, respectively, the refractive indexes thereof in the direction of a Y-axis, which is the direction perpendicular to the Z-axis and the X-axis, are denoted by ny1 and ny2, respectively, and the thickness thereof in the Z-axis direction is denoted by d1 and d2, respectively, then nx1>ny1>nz1 and nx2>ny2>nz2 hold, and a sum W1 of the phase difference value within an XY plane and in the Z-axis direction in the first retardation film ((nx1+ny1)/2−nz1)×d1 and the phase difference value in the second retardation film ((nx2+ny2)/2−nz2)×d2 is expressed as 0.5×Rt≦W1≦0.75×Rt if the phase difference value of the liquid crystal layer in the transmissive region is denoted by Rt.

9. The liquid crystal display device according to claim 3, if the refractive indexes of the first retardation film and the third retardation film in the direction of the Z-axis, which is the direction of their thickness, are denoted by nz1 and nz3, respectively, the refractive indexes thereof in the direction of the X-axis, which is one direction in the plane perpendicular to the Z-axis, are denoted by nx1 and nx3, respectively, the refractive indexes thereof in the direction of the Y-axis, which is the direction perpendicular to the Z-axis and the X-axis, are denoted by ny1 and ny3, respectively, and the thickness thereof in the Z-axis direction is denoted by d1 and d3, respectively, then nx1>ny1>nz1 and nx3≈ny3>nz3 hold, and a sum W2 of the phase difference value within the XY plane and in the Z-axis direction in the first retardation film ((nx1+ny1)/2−nz1)×d1 and the phase difference value in the third retardation film ((nx3+ny3)/2−nz3)×d3 is expressed as 0.5×Rt≦W2≦0.75×Rt if the phase difference value of the liquid crystal layer in the transmissive region is denoted by Rt.

10. The liquid crystal display device according to claim 3, if the refractive indexes of the first retardation film, the third retardation film and the fourth retardation film in the direction of the Z-axis, which is the direction of their thickness, are denoted by nz1, nz3 and nz4, respectively, the refractive indexes thereof in the direction of the X-axis, which is one direction in the plane perpendicular to the Z-axis, are denoted by nx1, nx3, and nx4, respectively, the refractive indexes thereof in the direction of the Y-axis, which is the direction perpendicular to the Z-axis and the X-axis, are denoted by ny1, ny3 and ny4, respectively, and the thicknesses thereof in the Z-axis direction are denoted by d1, d3 and d4, respectively, then nx1>ny1>nz1 and nx3≈ny3>nz3 and nx4>ny4≈nz4 hold, and the sum W2 of the phase difference value within the XY plane and in the Z-axis direction in the first retardation film ((nx1+ny1)/2−nz1)×d1, the phase difference value in the third retardation film ((nx3+ny3)/2−nz3)×d3, and the phase difference value within the XY plane and in the Z-axis direction of the fourth retardation film ((nx4+ny4)/2−nz4)×d4 is expressed as 0.5×Rt≦W2≦0.75×Rt if the phase difference value of the liquid crystal layer in the transmissive region is denoted by Rt.

11. The liquid crystal display device according to claim 4, if the refractive indexes of the first retardation film and the fourth retardation film in the direction of the Z-axis, which is the direction of their thickness, are denoted by nz1 and nz4, respectively, the refractive indexes thereof in the direction of the X-axis, which is one direction in the plane perpendicular to Z-axis, are denoted by nx1 and nx4, respectively, the refractive indexes thereof in the direction of the Y-axis, which is the direction perpendicular to the Z-axis and the X-axis, are denoted by ny1 and ny4 respectively, and the thicknesses thereof in the Z-axis direction are denoted by d1 and d4, respectively, then nx1>ny1>nz1 and nx4>ny4≈nz4 hold, and the sum W2 of the phase difference value within the XY plane and in the Z-axis direction in the first retardation film ((nx1+ny1)/2−nz1)×d1 and the phase difference value within the XY plane and in the Z-axis direction in the fourth retardation film ((nx4+ny4)/2−nz4)×d4 is expressed as 0.5×Rt≦W2≦0.75×Rt if the phase difference value of the liquid crystal layer in the transmissive region is denoted by Rt.

12. The liquid crystal display device according to claim 5, if the refractive indexes of the second retardation film and the fifth retardation film in the direction of the Z-axis, which is the direction of their thickness, are denoted by nz2 and nz5, respectively, the refractive indexes thereof in the direction of the X-axis, which is one direction in the plane perpendicular to the Z-axis, are denoted by nx2 and nx5, respectively, the refractive indexes thereof in the direction of the Y-axis, which is the direction perpendicular to the Z-axis and the X-axis, are denoted by ny2 and ny5, respectively, and the thicknesses thereof in the Z-axis direction are denoted by d2 and d5, respectively, then nx2>ny2>nz2 and nx5≈ny5>nz5 hold, and a sum W3 of the phase difference value within the XY plane and in the Z-axis direction in the second retardation film ((nx2+ny2)/2−nz2)×d2 and the phase difference value in the fifth retardation film ((nx5+ny5)/2−nz5)×d5 is expressed as 0.5×Rt≦W3≦0.75×Rt if the phase difference value of the liquid crystal layer in the transmissive region is denoted by Rt.

13. The liquid crystal display device according to claim 5, if the refractive indexes of the second retardation film, the fifth retardation film and the sixth retardation film in the direction of the Z-axis, which is the direction of their thickness, are denoted by nz2, nz5 and nz6, respectively, the refractive indexes thereof in the direction of the X-axis, which is one direction in the plane perpendicular to Z-axis, are denoted by nx2, nx5, and nx6, respectively, the refractive indexes thereof in the direction of the Y-axis, which is the direction perpendicular to the Z-axis and the X-axis, are denoted by ny2, ny5 and ny6, respectively, and the thicknesses thereof in the Z-axis direction are denoted by d2, d5 and d6, respectively, then nx2>ny2>nz2, nx5≈ny5>nz5 and nx6>ny6≈nz6 hold, and the sum W3 of the phase difference value within the XY plane and in the Z-axis direction in the second retardation film ((nx2+ny2)/2−nz2)×d2, the phase difference value in the fifth retardation film ((nx5+ny5)/2−nz5)×d5, and the phase difference value within the XY plane and in the Z-axis direction in the sixth retardation film ((nx6+ny6)/2−nz6)×6 is expressed as 0.5×Rt≦W3≦0.75×Rt if the phase difference value of the liquid crystal layer in the transmissive region is denoted by Rt.

14. The liquid crystal display device according to claim 6, if the refractive indexes of the second retardation film and the sixth retardation film in the direction of the Z-axis, which is the direction of their thickness, are denoted by nz2 and nz6, respectively, the refractive indexes thereof in the direction of the X-axis, which is one direction in the plane perpendicular to Z-axis, are denoted by nx2 and nx6, respectively, the refractive indexes thereof in the direction of the Y-axis, which is the direction perpendicular to the Z-axis and the X-axis, are denoted by ny2 and ny6, respectively, and the thicknesses thereof in the Z-axis direction are denoted by d2 and d6, respectively, then nx2>ny2>nz2 and nx6>ny6≈nz6 hold, and the sum W3 of the phase difference value within the XY plane and in the Z-axis direction in the second retardation film ((nx2+ny2)/2−nz2)×d2 and the phase difference value within the XY plane and in the Z-axis direction in the sixth retardation film ((nx6+ny6)/2−nz6)×d6 is expressed as 0.5×Rt≦W3≦0.75×Rt if the phase difference value of the liquid crystal layer in the transmissive region is denoted by Rt.

15. The liquid crystal display device according to claim 2, if the refractive indexes of the first retardation film and the second retardation film in the direction of the X-axis, which is one direction in the plane perpendicular to the direction of their thickness (Z-axis) are denoted by nx1 and nx2, respectively, the refractive indexes thereof in the direction of the Y-axis, which is the direction perpendicular to the Z-axis and the X-axis are denoted by ny1, ny2(nx1>ny1, nx2>ny2), and the thicknesses thereof in the Z-axis direction are denoted by d1 and d2, respectively, then the X-axis of the first retardation film and the X-axis of the second retardation film are orthogonal to each other, and (nx1−ny1)×d1=(nx2−ny2)×d2.

16. The liquid crystal display device according to claim 3, if the refractive indexes of the first retardation film and the fourth retardation film in the direction of the X-axis, which is one direction in the plane perpendicular to the direction of their thickness (Z-axis), are denoted by nx1 and nx4, respectively, the refractive indexes thereof in the direction of the Y-axis, which is the direction perpendicular to the Z-axis and the X-axis are denoted by ny1, ny4(nx1>ny1, nx4>ny4), and the thicknesses thereof in the Z-axis direction are denoted by d1 and d4, then the X-axis of the first retardation film and the X-axis of the fourth retardation film are orthogonal to each other, and (nx1−ny1)×d1=(nx4−ny4)×d4.

17. The liquid crystal display device according to claim 5 if the refractive indexes of the second retardation film and the sixth retardation film in the direction of the X-axis, which is one direction in the plane perpendicular to the direction of their thickness (Z-axis), are denoted by nx2 and ny6, respectively, the refractive indexes thereof in the direction of the Y-axis, which is the direction perpendicular to the Z-axis and the X-axis, are denoted by ny2, ny6(nx2>ny2, nx6>ny6), and the thicknesses thereof in the Z-axis direction are denoted by d2 and d6, respectively, then the X-axis of the second retardation film and the X-axis of the sixth retardation film are orthogonal to each other, and (nx2−ny2)×d2=(nx6−ny6)×d6.

18. The liquid crystal display device according to claim 15, the first retardation film and the second retardation film being expressed by 100 nm≦(nx1−ny1)×d1=(nx2−ny2)×d2≦160 nm.

19. The liquid crystal display device according to claim 16, the first retardation film and the fourth retardation film being expressed by 100 nm≦(nx1−ny1)×d1=(nx4−ny4)×d4≦160 nm.

20. The liquid crystal display device according to claim 17, the second retardation film and the sixth retardation film being expressed by 100 nm≦(nx2−ny2)×d2=(nx6−ny6)×d6≦160 nm.

21. The liquid crystal display device according to claim 1, the ratio R(450)/R(590) of an in-plane phase difference value R (450) of 450 nm to an in-plane phase difference value R (590) of 590 nm in at least one of the first retardation film, the second retardation film, the fourth retardation film and the sixth retardation film being smaller than 1.

22. The liquid crystal display device according to claim 1, the transmission axis of the first polarizer and the transmission axis of the second polarizer being orthogonal to each other.

23. The liquid crystal display device according to claim 1, the phase difference value within the XY plane and in the Z-axis direction in the first retardation film ((nx1+ny1)/2−nz1)×d1 being substantially equal to the phase difference value in the second retardation film ((nx2+ny2)/2−nz2)×d2.

24. The liquid crystal display device according to claim 3, the phase difference value in the XY plane and in the Z-axis direction in the first retardation film ((nx1+ny1)/2−nz1)×d1 being substantially equal to the phase difference value in the third retardation film ((nx3+ny3)/2−nz3)×d3.

25. The liquid crystal display device according to claim 5, the phase difference value within the XY plane and in the Z-axis direction in the fifth retardation film ((nx5+ny5)/2−nz5)×d5 being substantially equal to the phase difference value in the second retardation film ((nx2+ny2)/2−nz2)×d2.

26. The liquid crystal display device according to claim 1, if the refractive index of the first retardation film in the direction of the Z-axis, which is the direction of their thickness, is denoted by nz1, the refractive index thereof in the direction of the X-axis, which is one direction in the plane perpendicular to the Z-axis, is noted as nx1, and the refractive index thereof in the direction of the Y-axis, which is the direction perpendicular to the Z-axis and the X-axis, is denoted by ny1, and the thickness thereof in the Z-axis direction is denoted by d1, then nx1>ny1>nz1 holds, and the phase difference value within the XY plane and in the Z-axis direction in the first retardation film ((nx1+ny1)/2−nz1)×d1 is 0.5×Rr≦(nx1+ny1)/2−nz1)×d1≦0.75×Rr when the phase difference value in the liquid crystal layer in the reflective region is denoted by Rr.

27. The liquid crystal display device according to claim 5, if the refractive index of the fifth retardation film in the direction of the Z-axis, which is the direction of their thickness, is denoted by nz5, the refractive index thereof in the direction of the X-axis, which is one direction in the plane perpendicular to the Z-axis is noted as nx5, and the refractive index thereof in the direction of the Y-axis, which is the direction perpendicular to the Z-axis and the X-axis, is denoted by ny5, and the thickness thereof in the Z-axis direction is denoted by d5, then nx5≈ny5>nz5 holds, and the phase difference value within the XY plane and in the Z-axis direction of the fifth retardation film ((nx5+ny5)/2−nz5)×d5 is 0.5×Rr≦(nx5+ny5)/2−nz5)×d5≦0.75×Rr when the phase difference value in the liquid crystal layer in the reflective region is denoted by Rr.

28. The liquid crystal display device according to claim 5, if the refractive indexes of the fifth retardation film and the sixth retardation film in the direction of the Z-axis, which is the direction of their thickness, are denoted by nz5 and nz6, respectively, the refractive indexes thereof in the direction of the X-axis, which is one direction in the plane perpendicular to Z-axis, are denoted by nx5 and nx6, respectively, the refractive indexes thereof in the direction of the Y-axis, which is the direction perpendicular to the Z-axis and the X-axis, are denoted by ny5 and ny6, respectively, and the thicknesses thereof in the Z-axis direction are denoted by d5 and d6, respectively, then nx5≈ny5>nz5 and nx6>ny6≈nz6 hold, and a sum W4 of the phase difference value within an XY plane and in the Z-axis direction of the fifth retardation film ((nx5+ny5)/2−nz5)×d5, and the phase difference value within the XY plane and in the Z-axis direction of the sixth retardation film ((nx6+ny6)/2−nz6)×d6 is expressed as 0.5×Rr≦W4≦0.75×Rr if the phase difference value in the liquid crystal layer in the reflective region is denoted by Rr.

29. The liquid crystal display device according to claim 1, wherein a reflection layer capable of reflecting incident light being formed in the reflective display region.

30. The liquid crystal display device according to claim 1, the reflection layer having an irregular configuration capable of performing scattered reflection of incident light.

31. The liquid crystal display device according to claim 1, the first retardation film and the second retardation film being orthogonal to each other in the X-axis direction, and the first retardation film and the second retardation film forming a substantially 45-degree angle with respect to the transmission axis of the first polarizer and the transmission axis of the second polarizer in the X-axis direction.

32. The liquid crystal display device according to claim 3, the first retardation film and the fourth retardation film being orthogonal to each other in the X-axis direction, and the first retardation film and the fourth retardation film forming a substantially 45-degree angle with respect to the transmission axis of the first polarizer and the transmission axis of the second polarizer in the X-axis direction.

33. The liquid crystal display device according to claim 5, the second retardation film and the sixth retardation film being orthogonal to each other in the X-axis direction, and the second retardation film and the sixth retardation film forming a substantially 45-degree angle with respect to the transmission axis of the first polarizer and the transmission axis of the second polarizer in the X-axis direction.

34. The liquid crystal display device according to claim 1, the inner surface of at least either the first substrate or the second substrate, the surface being adjacent to the liquid crystal layer, being provided with an electrode having an opening to drive the liquid crystal.

35. The liquid crystal display device according to claim 1, a protuberance being formed on the electrode formed on the inner surface of at least either the first substrate or the second substrate, the surface being adjacent to the liquid crystal layer.

36. The liquid crystal display device according to claim 1, there are at least two liquid crystal directors in one dot when the liquid crystal being driven by the electrode.

37. Electronic equipment, comprising:
the liquid crystal display device according to claim 1.
